(19) United States
(12) Patent Application Publication
(10) Pub. No.: US 2007/0079096 A1
(43) Pub. Date: Apr. 5, 2007

(54) Data storage unit access authorization table automatic rebuilding method and system

(76) Inventor: Chih-Wei Chen, Taipei (TW)

Correspondence Address: PEARL COHEN ZEDEK LATZER, LLP, 1500 BROADWAY 12TH FLOOR, NEW YORK, NY, 10036, US

(21) Appl. No.: 11/239,207

(22) Filed: Sep. 30, 2005

(51) Int. Cl. G06F 12/00; G06F 12/14

(52) U.S. Cl. 711/170; 711/163

(57) ABSTRACT

A data storage unit access authorization table automatic rebuilding method and system is proposed, which is designed for use with a data storage unit for providing an access authorization table automatic rebuilding capability for the data storage unit, and which is characterized by the capability of partitioning a special area from the storage space of the data storage unit for the storage of access authorization data, such that in the event that the data storage unit is removed from a first computer platform and reinstalled on a second one, it allows the second computer platform to automatically rebuild an access authorization table that is identical with the original access authorization table on the first computer platform by retrieving the access authorization data stored in the data storage unit. In SAN applications, this feature allows the overall SAN management work to be more convenient and efficient

### BACKGROUND OF THE INVENTION

1. Field of the Invention:

This invention relates to information technology (IT), and more particularly, to a data storage unit access authorization table automatic rebuilding method and system which is designed for use in conjunction with a data storage unit, such as a RAID (Redundant Array of Independent Disks) unit, for providing an access authorization table automatic rebuilding capability to the RAID unit in the event that the RAID unit is removed from a first its original computer platform and installed onto another computer platform, for the purpose of allowing the other computer platform to rebuild an access authorization table for the RAID unit that is identical with the access authorization table previously built on the original computer platform.

2. Description of Related Art

SAN (Storage Area Network) is a networking architecture which connects high-volume storage units to a network system so as to allow network servers or clients to gain access via the network system to the high-volume storage units In practical applications, SAN typically utilizes RAID (Redundant Array of Independent Disks) for providing the high-volume data storage capacity. A RAID unit is a multi-disk storage unit that contains two or more hard disks, commonly connected in a network system to one or more servers for these servers to store the large amount of data that flow through the network system. Since a RAID unit contains a cluster of independent disks, it allows an interleaved access method that can significantly enhance data access speed, and is further capable of providing a multiple backup function that allows the storage of data to be highly reliable and secured.

In actual operations, however, servers in a SAN system could occasionally fail to operate normally, causing SAN clients unable to gain access to the data stored in the RAID units that are controlled by a failed server. Under this condition, network management personnel may need to remove the RAID unit from the failed server and reinstalled the RAID unit onto a backup server, so as to allow SAN clients to gain access to the RAID unit via the backup server.

In the above-mentioned removal and reinstallation procedure, if the failed server has built an access authorization table for the RAID unit (where the access authorization table is used to store information about a group of servers that are authorized to gain access to the RAID unit), then since this access authorization table is traditionally stored in a NVRAM (Non-Volatile Random-Access Memory), the access authorization table data won't be able to be transferred to the backup server along with the relocated RAID unit. For this sake, when the RAID unit is removed from a failed server and reinstalled on a backup server, the network management personnel will have to manually input the related access authorization data for the purpose of rebuilding an access authorization table that is identical with the original access authorization table built on the failed server

One drawback to the forgoing manually-performed access authorization table rebuilding procedure, however, is that it requires the network management personnel to thoroughly understand the RAID unit's original system configurations and authorization data, including all the LUNs (Logic Unit Number) of the RAID unit, the UUID (Universal Unique Identifier) of each logical unit in the RAID unit, and the ID numbers of servers that are authorized to gain access to the RAID unit. All these data are then inputted to the backup server manually by the network management personnel to rebuild an access authorization table that is identical with the original access authorization table built on the failed server. Since the manually-performed access authorization table rebuilding procedure is quite tedious, laborious, and timing-consuming, it would make the SAN management work very inefficient

### SUMMARY OF THE INVENTION

It is therefore an objective of this invention to provide a data storage unit access authorization table automatic rebuilding method and system which can be used in the event that a RAID unit is removed from a first server and reinstalled on a second server to allow the second server to automatically rebuild an access authorization table for the relocated RAID unit that is identical with the original access authorization table built on the first server, so that the overall SAN management work can be made more convenient and efficient.

The data storage unit access authorization table automatic rebuilding method and system according to the invention is designed for use in conjunction with a data storage unit, such as a RAID (Redundant Array of Independent Disks) unit, for providing an access authorization table automatic rebuilding capability to the RAID unit in the event that the RAID unit is removed from a first its original computer platform and installed onto another computer platform, for the purpose of allowing the other computer platform to rebuild an access authorization table for the RAID unit that is identical with the access authorization table previously built on the original computer platform.

The data storage unit access authorization table automatic rebuilding method according to the invention comprises: (1) on the first computer platform, responding to an access authorization table building event by partitioning an access authorization table storage area from the storage space of the data storage unit; (2) on the first computer platform, storing an access authorization table built by the first computer platform into the access authorization table storage area in the data storage unit; (3) in the event of the data storage unit being removed from the first computer platform and reinstalled on the second computer platform, responding to the data storage unit reinstallation event on the second computer platform by retrieving the access authorization table data stored in the access authorization table storage area in the data storage unit; and (4) on the second computer platform, rebuilding an access authorization table for the second computer platform based on the access authorization table data retrieved from the access authorization table storage area in the data storage unit.

In terms of architecture, the data storage unit access authorization table automatic rebuilding system according to the invention is based on a distributed architecture comprising: (A) an original-side processing unit; and (B) a destination-side processing unit; wherein the original-side processing unit is installed on the first computer platform, and which includes: (A1) an access authorization table storage area partitioning module, which is capable of being activated in response to an access authorization table building event to partition an access authorization table storage area from the storage space of the data storage unit; and (A2) an access authorization table storing module, which is capable of storing an access authorization table built by the first computer platform into the access authorization table storage area in the data storage unit; and wherein the destination-side processing unit is installed on the second computer platform, and which includes: (B1) an access authorization table data retrieval module, which is capable of responding to a data storage unit reinstallation event in which the data storage unit is removed from the first computer platform and reinstalled onto the second computer platform, by retrieving the access authorization table data stored in the access authorization table storage area in the data storage unit; and (B2) an access authorization table rebuilding module, which is capable of rebuilding an access authorization table for the second computer platform based on the access authorization table data retrieved by the access authorization table data retrieval module from the access authorization table storage area in the data storage unit.

The data storage unit access authorization table automatic rebuilding method and system according to the invention is characterized by the capability of partitioning a special area from the storage space of a data storage unit for the storage of access authorization table data, such that in the event that the data storage unit is removed from a first computer platform and reinstalled on a second computer platform, it allows the second computer platform to automatically rebuild an access authorization table that is identical with the original access authorization table on the first computer platform by retrieving the access authorization table data stored in the data storage unit. In SAN applications, this feature can be used in the event that a RAID unit is removed from a failed server and reinstalled on another server to allow the other server to automatically rebuild an access authorization table for the relocated RAID unit without human intervention, so that the overall SAN management work can be more convenient and efficient

### BRIEF DESCRIPTION OF DRAWINGS

The invention can be more fully understood by reading the following detailed description of the preferred embodiments, with reference made to the accompanying drawings, wherein:

FIGS. 1A-1B are schematic diagrams used to depict the utilization purpose of the data storage unit access authorization table automatic rebuilding method and system according to the invention;

FIG. 2 is a schematic diagram showing the distributed system architecture of the data storage unit access authorization table automatic rebuilding system of the invention;

FIG. 3 is a schematic diagram showing the object-oriented component model of the internal architecture of an original-side processing unit utilized by the data storage unit access authorization table automatic rebuilding system of the invention; and

FIG. 4 is a schematic diagram showing the object-oriented component model of the internal architecture of a destination-side processing unit utilized by the data storage unit access authorization table automatic rebuilding system of the invention

### DETAILED DESCRIPTION OF PREFERRED EMBODIMENTS

The data storage unit access authorization table automatic rebuilding method and system according to the invention is disclosed in full details by way of preferred embodiments in the following with reference to the accompanying drawings

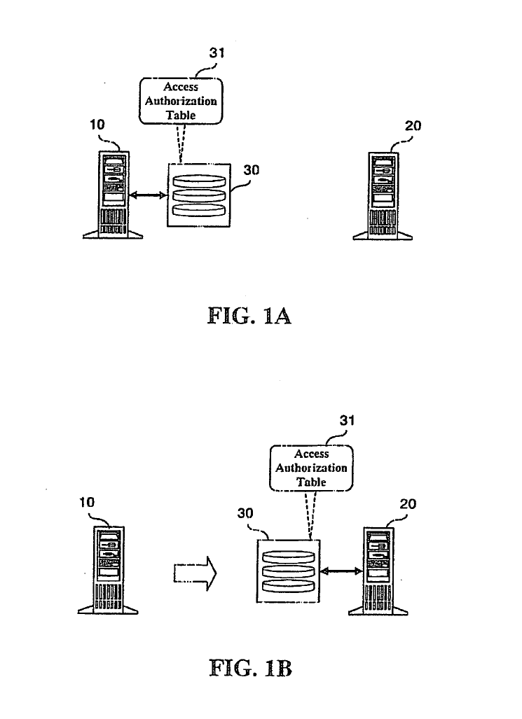

FIGS. 1A-1B are used to depict the utilization purpose of the data storage unit access authorization table automatic rebuilding method and system according to the invention As shown in FIG. 1A, it is assumed that there is a first computer platform 10 installed with a data storage unit 30, where the first computer platform 10 is for example a network server in a SAN (Storage Area Network) system, while the data storage unit 30 is for example a RAID (Redundant Array of Independent Disks) unit which is built with an access authorization table 31. As shown in FIG. 1B, in the event that the RAID unit 30 is removed from the first computer platform 10 and installed onto a second computer platform 20 (such as another server in the SAN system), the invention will allow the second computer platform 20 to automatically rebuild an access authorization table 31 for the installed RAID unit 30 that is identically to the original access authorization table 31 built on the first computer platform 10.

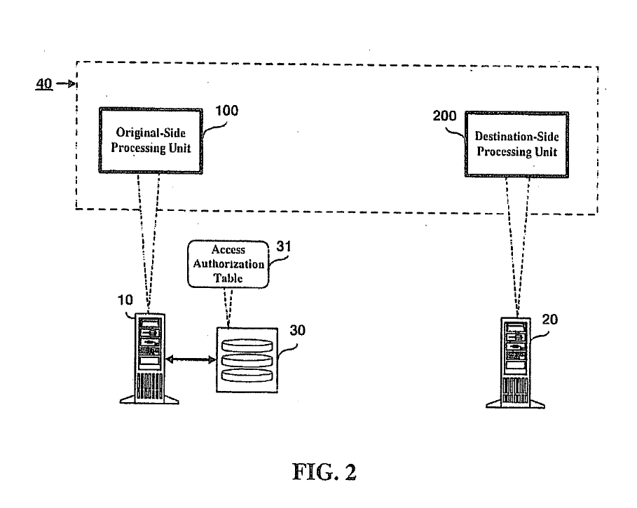

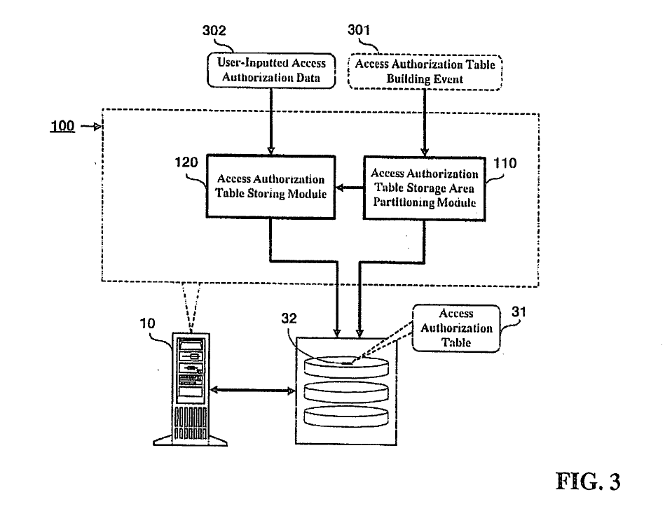

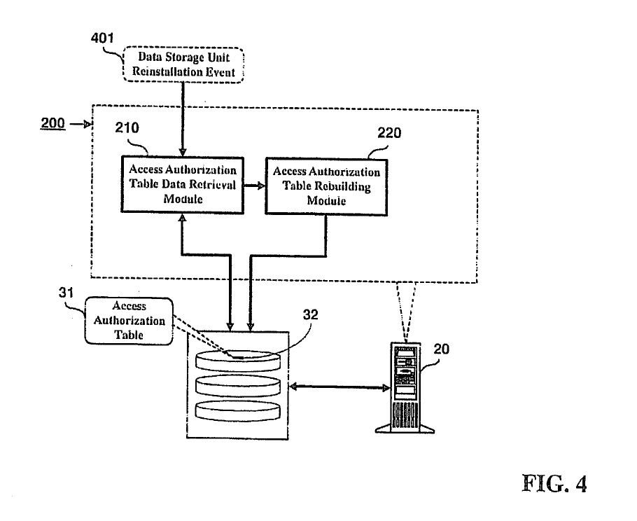

As shown in FIG. 2, the data storage unit access authorization table automatic rebuilding system according to the invention (as the part enclosed in the dotted box indicated by the reference numeral 40 in FIG. 2) is based on a distributed architecture comprising: (A) an original-side processing unit 100; and (B) a destination-side processing unit 200; wherein as shown in FIG. 3, the original-side processing unit 100 is installed on the first computer platform 10 and whose internal architecture includes: (A1) an access authorization table storage area partitioning module 110; and (A2) an access authorization table storing module 120; and wherein as shown in FIG. 4, the destination-side processing unit 200 is installed on the second computer platform 20 and whose internal architecture includes: (B1) an access authorization table data retrieval module 210; and (B2) an access authorization table rebuilding module 220.

Firstly, the respective attributes and functions of the constituent modules 110, 120, of the original-side processing unit 100 installed on the first computer platform 10 are described in details in the following.

The access authorization table storage area partitioning module 110 is installed on the first computer platform 10, and which is capable of being activated in response to a user-initiated access authorization table building event 301 (i.e., in the event that the network management personnel intends to build an access authorization table for the RAID unit 30 on the first computer platform 10) to partition a special area from the storage space of the RAID unit 30 to be used as an access authorization table storage area 32.

The access authorization table storing module 120 is capable of responding to the access authorization table building event 301 by receiving a user-inputted set of access authorization data 302 and storing the received access authorization data 302 into the access authorization table storage area 32 in the RAID unit 30 In practice, for example, the data stored in the access authorization table 31 includes all the LUNs (Logic Unit Number) of the RAID unit 30, the UUID (Universal Unique Identifier) of each logical unit in the RAID unit 30, and the ID numbers of servers that are authorized to gain access to the logic units in the RAID unit 30.

Next, the respective attributes and functions of the constituent modules 210, 220 of the destination-side processing unit 200 installed on the second computer platform 20 are described in details in the following.

The access authorization table data retrieval module 210 is installed on the destination-side processing unit 200, and which is capable of responding to a data storage unit reinstallation event 401 (i.e., when the RAID unit 30 is removed from the first computer platform 10 and reinstalled onto the second computer platform 20) by retrieving the access authorization table data stored in the access authorization table storage area 32 in the reinstalled RAID unit 30

The access authorization table rebuilding module 220 is capable of automatically rebuilding an access authorization table 31 for the second computer platform 20 based on the access authorization table data retrieved by the access authorization table data retrieval module 210 from the access authorization table storage area 32 in the reinstalled RAID unit 30, wherein the rebuilt access authorization table 31 on the second computer platform 20 is completely identical to the original access authorization table 31 built on the first computer platform 10

The following is a detailed description of an example of a practical application of the data storage unit access authorization table automatic rebuilding system of the invention 40 in actual operation.

Referring to FIG. 1 through FIG. 4 together, in actual operation, when the RAID unit 30 is initially installed to the first computer platform 10, the access authorization table storage area partitioning module 110 in the original-side processing unit 100 of the data storage unit access authorization table automatic rebuilding system of the invention 40 will be activated in response to a user-initiated access authorization table building event 301 to partition an access authorization table storage area 32 from the storage space of the RAID unit 30 (by comparison, the prior art utilizes a hardware NVRAM for providing such an access authorization table storage area). Subsequently, the access authorization table storing module 120 is activated to receive a user-inputted set of access authorization data 302 and storing the received access authorization data 302 into the access authorization table storage area 32 in the RAID unit 30

During normal operation of the first computer platform 10, when an externally linked network workstation or another server (not shown) requests to gain access to the RAID unit 30, the first computer platform 10 can then refer to the access authorization table 31 stored in the access authorization table storage area 32 of the RAID unit 30 to verify whether the externally-linked network workstation or another server (not shown) is authorized to gain access to the requested logical units in the RAID unit 30

When the RAID unit 30 is removed from the first computer platform 10 and reinstalled on the second computer platform 20 (thus initiating a data storage unit reinstallation event 401 at the second computer platform 20), the access authorization table data retrieval module 210 in the destination-side processing unit 200 installed on the second computer platform 20 will be activated in response to the data storage unit reinstallation event 401 by retrieving the access authorization table data stored in the access authorization table storage area 32 in the reinstalled RAID unit 30. Subsequently, the access authorization table rebuilding module 220 is activated to automatically rebuilding an access authorization table 31 for the second computer platform 20 based on the access authorization table data retrieved by the access authorization table data retrieval module 210 from the access authorization table storage area 32 in the reinstalled RAID unit 30, wherein the rebuilt access authorization table 31 on the second computer platform 20 is completely identical to the original access authorization table 31 built on the first computer platform 10

Consequently, during operation of the second computer platform 20, when an externally linked network workstation or another server (not shown) requests to gain access to the RAID unit 30, the second computer platform 20 can refer to the rebuilt access authorization table 31 to verify whether the externally-linked network workstation or another server (not shown) is authorized to gain access to the requested logical units in the RAID unit 30

In conclusion, the invention provides a data storage unit access authorization table automatic rebuilding method and system for use with a data storage unit for providing an access authorization table automatic rebuilding capability for the data storage unit, and which is characterized by the capability of partitioning a special area from the storage space of a data storage unit for the storage of access authorization table data, such that in the event that the data storage unit is removed from a first computer platform and reinstalled on a second computer platform, it allows the second computer platform to automatically rebuild an access authorization table that is identical with the original access authorization table on the first computer platform by retrieving the access authorization table data stored in the data storage unit In SAN applications, this feature can be used in the event that a RAID unit is removed from a failed server and reinstalled on another server to allow the other server to automatically rebuild an access authorization table for the relocated RAID unit without human intervention, so that the overall SAN management work can be more convenient and efficient. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements

What is claimed is:

1. A data storage unit access authorization table automatic rebuilding method for use on a first computer platform and a second computer platform, wherein the first computer platform data is originally installed with a data storage unit and has built an access authorization table for the data storage unit, for providing the data storage unit with an access authorization table automatic rebuilding function in the event that the data storage unit is removed from the first computer platform and reinstalled onto the second computer platform, for the purpose of allowing the second computer platform to automatically rebuild an access authorization table for the reinstalled data storage unit that is identical with the original access authorization table built on the first computer platform;
the data storage unit access authorization table automatic rebuilding method comprising:
on the first computer platform, responding to an access authorization table building event by partitioning an access authorization table storage area from the storage space of the data storage unit;
on the first computer platform, storing an access authorization table built by the first computer platform into the access authorization table storage area in the data storage unit;
in the event of the data storage unit being removed from the first computer platform and reinstalled on the second computer platform, responding to the data storage unit reinstallation event on the second computer platform by retrieving the access authorization table data stored in the access authorization table storage area in the data storage unit; and
on the second computer platform, rebuilding an access authorization table for the second computer platform based on the access authorization table data retrieved from the access authorization table storage area in the data storage unit

2. The data storage unit access authorization table automatic rebuilding method of claim 1, wherein the first computer platform and the second computer platform are both network servers.

3. The data storage unit access authorization table automatic rebuilding method of claim 1, wherein the data storage unit is a RAID (Redundant Array of Independent Disks) unit

4. A data storage unit access authorization table automatic rebuilding system for use with a first computer platform and a second computer platform, wherein the first computer platform data is originally installed with a data storage unit and has built an access authorization table for the data storage unit, for providing the data storage unit with an access authorization table automatic rebuilding function in the event that the data storage unit is removed from the first computer platform and reinstalled onto the second computer platform, for the purpose of allowing the second computer platform to automatically rebuild an access authorization table for the reinstalled data storage unit that is identical with the original access authorization table built on the first computer platform;
the data storage unit access authorization table automatic rebuilding system comprising an original-side processing unit and a destination-side processing unit;
wherein
the original-side processing unit is installed on the first computer platform, and which includes:
an access authorization table storage area partitioning module, which is capable of being activated in response to an access authorization table building event to partition an access authorization table storage area from the storage space of the data storage unit; and
an access authorization table storing module, which is capable of storing an access authorization table built by the first computer platform into the access authorization table storage area in the data storage unit;
and wherein
the destination-side processing unit is installed on the second computer platform, and which includes:
an access authorization table data retrieval module, which is capable of responding to a data storage unit reinstallation event in which the data storage unit is removed from the first computer platform and reinstalled onto the second computer platform, by retrieving the access authorization table data stored in the access authorization table storage area in the data storage unit; and
an access authorization table rebuilding module, which is capable of rebuilding an access authorization table for the second computer platform based on the access authorization table data retrieved by the access authorization table data retrieval module from the access authorization table storage area in the data storage unit.

5. The data storage unit access authorization table automatic rebuilding system of claim 4, wherein the first computer platform and the second computer platform are both network servers

6. The data storage unit access authorization table automatic rebuilding system of claim 4, wherein the data storage unit is a RAID (Redundant Array of Independent Disks) unit.
